(19) United States
(12) Patent Application Publication
(10) Pub. No.: US 2013/0104233 A1
(43) Pub. Date: Apr. 25, 2013

(54) NETWORK DATA CONTROL DEVICE AND NETWORK DATA CONTROL METHOD FOR CONTROLING NETWORK DATA THAT GENERATES MALICIOUS CODE IN MOBILE EQUIPMENT

(71) Applicants: Chan Park, Paju-si (KR); Duk gi Jung, Seoul (KR)

(72) Inventors: Chan Park, Paju-si (KR); Duk gi Jung, Seoul (KR)

(73) Assignee: THE FRONS INC., Seoul (KR)

(21) Appl. No.: 13/807,056

(22) PCT Filed: Sep. 14, 2010
(86) PCT No.: PCT/KR2010/006267

§ 371 Date: Dec. 27, 2012

(30) Foreign Application Priority Data
Jun. 28, 2010 (KR) 10-2010-0061353

(51) Int. Cl. H04L 29/06

(52) U.S. Cl. CPC H04L 63/1441; H04L 63/1425
USPC 726/23

(57) ABSTRACT

Provided are a device and a method of controlling network data induced by a malicious code of a mobile apparatus. Information input by a user through an input unit of a mobile apparatus is analyzed to determine whether or not the network data generated in the mobile apparatus are network data which are generated in accordance with user's intention, the network data generated in accordance with user's intention are transmitted to an external communication network, the network data which are generated irrespective of user's intention is consider to be network data which causes extrusion of personal information of the user which is induced by the malicious code residing in the mobile apparatus or an external attacker or network data which attack the external communication network, so that transmission of the network data to the external communication network is blocked.

### TECHNICAL FIELD

The present invention relates to a network data control device and a network data control method, and more particularly, to a network data control device and a network data control method which controls network data that are induced by malicious code of a mobile apparatus.

### BACKGROUND ART

Recently, among various types of network attacks, zero-day attacks such as worms or bots most frequently occur, and damage caused by the attacks are gradually increased. Features of these attacks are that attackers thereof automatically search for weak points through the network and propagate themselves and the attacks are spread at a high speed through weak systems connected through the Internet.

However, in the related art, in a network attack detection technique which is operated based on signature, since it is determined based on known signature whether or not a malicious code exists, there is a limitation to defend a new type of attack which is not yet known.

Today, most network security systems uses a method of detecting and blocking attack traffic by using a signature-based attack detection rule. However, in order to apply the attack detection rule to the network security system, the attack traffic is collected and an expert analyzes the attack traffic to extract signature and generate an attack detection rule. Subsequently, after the experts perform verification of function thereof, if there is no problem, the attack detection rule is applied to the network security system.

According to the method in the related art, much time and efforts are needed for determination of the attack, extraction of the signature, generation and verification of the attack detection rule, and application of the attack detection rule to the network security system. In addition, there is a problem in that a time lag from the recognition of occurrence of attack to the application of the attack detection rule to the network security system causes failure in initial suppression of the network attack and great damages.

In addition, most network security systems are located just in front of to-be-protected system or local network. Because of this limitation in location of the network security system, defense is performed after many attack traffics pass through the Internet as a public network, and thus, attacking network data occupy many band widths in the Internet.

Because of this physical location of the network security system, there is a problem in that, similarly to DDoS attacks, many attack traffics generated from many systems which are allowed to be Zombie systems by instruction of an attacker cause damage of loss in band width of the Internet. The loss in band width of the Internet causes direct property damages to Internet service providers which install and manage the Internet. In addition, the loss in band width causes a decrease in network rate to the public persons who subscribe to services of the Internet service providers to utilize the Internet services.

Recently, mobile apparatuses capable of accessing a network such as smart phones are rapidly spread. Therefore, the number of electronic apparatuses which are infected by malicious codes to generate the attacking network data is rapidly increased. Particularly, since most mobile apparatuses use paid network of which the fee is charged based on an amount of transmitted and received data, in the case where a mobile apparatus of a user which is infected by a malicious code generates a large amount of the attacking network data and transmits the attacking network data to a network without user's recognition thereof, the mobile apparatus may make a call to a specific phone number to cause property damages to the user. In this manner, the attacking network data may directly cause great property damages to the user. In addition, personal information stored in the mobile apparatus is allowed to to be transmitted to a specific person to cause damages induced by extrusion of the personal information.

### DISCLOSURE

### Technical Problem

The present invention is to provide a network data control device and a network data control method capable of effectively blocking transmission of network data, which are generated by a malicious code in a mobile apparatus infected by the malicious code, to an external communication network.

### Technical Solution

In order to solve the aforementioned problems, the present invention is to provide a network data control device and a network data control method which controls network data generated by a malicious code in a mobile apparatus, wherein it is determined whether the network data output through a network interface of the mobile apparatus are network data which are generated in accordance with user's intention or network data which are generated by the malicious code for extrusion of personal information or attack on other systems irrespective of user's intention, the network data which are generated in accordance with user's intention are transmitted to an external network, and transmission of the network data which are generated by the malicious code irrespective of user's intention is blocked, so that it is possible to effectively control the network data which are generated by the malicious code.

It should be noted that a network described hereinafter includes a wired Internet, a wireless Internet, a mobile communication network, a local area network (LAN), electronic apparatuses connected through USB, or IEEE 1394 method in a broad sense.

According to an aspect of the present invention, there is provided a network data control device which is installed in a mobile apparatus to control network data induced by a malicious code of the mobile apparatus, wherein the network data control device analyzes information which is input by a user through an input unit of the mobile apparatus and blocks transmission of the network data which are not in accordance with user's intention to an external communication network.

In addition, the network data control device may include an input information analysis unit which analyzes the information which is input by the user through the input unit of the mobile apparatus; a network data monitoring unit which monitors the network data generated in the mobile apparatus; a data transmission unit which transmits the network data to the external communication network or blocks the transmission of the network data to the external communication network according to a control signal; and a network data determination unit which outputs the control signal instructing the blocking of transmission of the network data if it is determined based on a result of the analysis of the input information analysis unit that the network data is not in accordance with user's intention.

In addition, in the input information analysis unit, the input information analysis unit may analyze the information which is input by the user through the input unit of the mobile apparatus and output first identification information which is used for identifying a program executed by the user, wherein the network data monitoring unit may monitor the network data which are generated in the mobile apparatus to generate second identification information which is used for identifying a program generating the network data, wherein the data transmission unit may receive the network data, temporarily store the network data, and transmit the temporarily stored network data to the external communication network according to the control signal, and wherein the network data determination unit may search for the first identification information corresponding to the second identification information and determine whether or not the network data are generated in accordance with user's intention to generate the control signal.

In addition, the first identification information may include information indicating the program which is executed by the user and data (user input data) input by the user through execution of the program.

In addition, the second identification information may include header information indicating a program which generates the network data extracted from the network data and data (user input data) input by the user.

In addition, the input unit of the mobile apparatus may include at least one of a touch screen, a keypad, and an audio recognition unit.

In addition, the input information analysis unit may recognize the executed program by identifying a position of an icon selected by the user on the touch screen or recognize the program driven by the user pushing a select button on the keypad to generate the first identification information.

In addition, in the case where the first identification information corresponding to the second identification information exists, the network data determination unit may determine that the network data are generated in accordance with user's intention, generate the control signal instructing the transmission of the network data, and output the control signal to the data transmission unit.

In addition, the network data determination unit may determine in units of a flow of the network data whether or not the first identification information corresponding to the second identification information exists.

In addition, in the case where the program executed by the user generates schedule information, the input information analysis unit may output the first identification information including the schedule information to the network data determination unit; and the network data determination unit may search for the first identification information corresponding to the second identification information which arrives at a scheduled time and determine whether or not the network data are generated in accordance with user's intention.

According to another aspect of the present invention, there is provided a network data control method performed in a network data control device which is installed in a mobile apparatus to control network data induced by a malicious code of the mobile apparatus, comprising steps of: (a) the network data control device, analyzing information which is input by a user through an input unit of the mobile apparatus; and (b) the network data control device, blocking transmission of the network data which are not in accordance with user's intention to an external communication network according to a result of the analysis.

In addition, the step (b) may include steps of: (b1) the network data control device, temporarily storing the network data generated in the mobile apparatus; (b2) the network data control device, determining based on a result of the analysis of the step (a) whether or not the network data are generated in accordance with user's intention; and (b3) if it is determined that the network data are generated irrespective of user's intention, the network data control device, blocking the transmission of the temporarily stored network data to the external communication network.

In addition, in the step (a), the network data control device may analyze the information which is input by the user through the input unit of the mobile apparatus and generate first identification information which is used for identifying a program executed by the user; in the step (b1), the network data control device may temporarily store the network data generated in the mobile apparatus and monitor the network data to generate second identification information which is used for identifying a program generating the network data; in the step (b2), the network data control device may search for the first identification information corresponding to the second identification information and determine whether or not the network data are generated in accordance with user's intention; and in the step (b3), if it is determined that the network data are generated in accordance with user's intention, the network data control device may transmit the temporarily stored network data to the external communication network.

In addition, the first identification information may include information indicating the program which is executed by the user and data (user input data) input by the user through execution of the program.

In addition, the second identification information may include header information indicating a program which generates the network data extracted from the network data and data (user input data) input by the user.

In addition, the input unit of the mobile apparatus may include at least one of a touch screen, a keypad, and an audio recognition unit.

In addition, in the step (a), the network data control device may recognize the executed program by identifying a position of an icon selected by the user on the touch screen or recognize the program driven by the user pushing a select button on the keypad to generate the first identification information.

In addition, in the step (c), the network data control device may determine in units of a flow of the network data whether or not the first identification information corresponding to the second identification information exists.

In addition, in the step (a), in the case where the program executed by the user generates schedule information, the network data control device may allow the schedule information to be included in the first identification information; and in the step (c), the network data control device may search for the first identification information corresponding to the second identification information which arrives at a scheduled time and determines whether or not the network data are generated in accordance with user's intention.

### Advantageous Effects

According to the present invention, information input by a user through an input unit of a mobile apparatus is analyzed to determine whether or not the network data generated in the mobile apparatus are network data which are generated in accordance with user's intention, the network data generated in accordance with user's intention are transmitted to an external communication network, the network data which are generated irrespective of user's intention is consider to be network data which causes extrusion of personal information of the user which is induced by the malicious code residing in the mobile apparatus or an external attacker or network data which attack the external communication network, so that transmission of the network data to the external communication network is blocked.

In this manner, the network data which are generated in the mobile apparatus are controlled according to user's intention, so that the transmission of the network data which are generated by the malicious code residing in the mobile apparatus or the external attacker is effectively blocked, so that it is possible to effectively prevent extrusion of the personal information of the user and the network attack.

### BRIEF DESCRIPTION OF DRAWINGS

FIG. 1 is a diagram illustrating a concept of a network data control method performed by a network data control device which controls network data generated by a malicious code of a mobile apparatus, according to an exemplary embodiment of the present invention.

FIG. 2 is a detailed block diagram illustrating a configuration of a network data control device 200 according to an exemplary embodiment of the present invention.

FIG. 3 is a flowchart illustrating a network data control method of controlling network data generated by a malicious code of a mobile apparatus 100 according to an exemplary embodiment of the present invention.

### DESCRIPTION OF REFERENCE NUMERALS

100 mobile apparatus
110 information processing unit
200 network data control device
210 input information analysis unit
220 network data monitoring unit
230 network data determination unit
240 data transmission unit

### BEST MODE

Hereinafter, exemplary embodiments of the present invention will be described with reference to attached drawings.

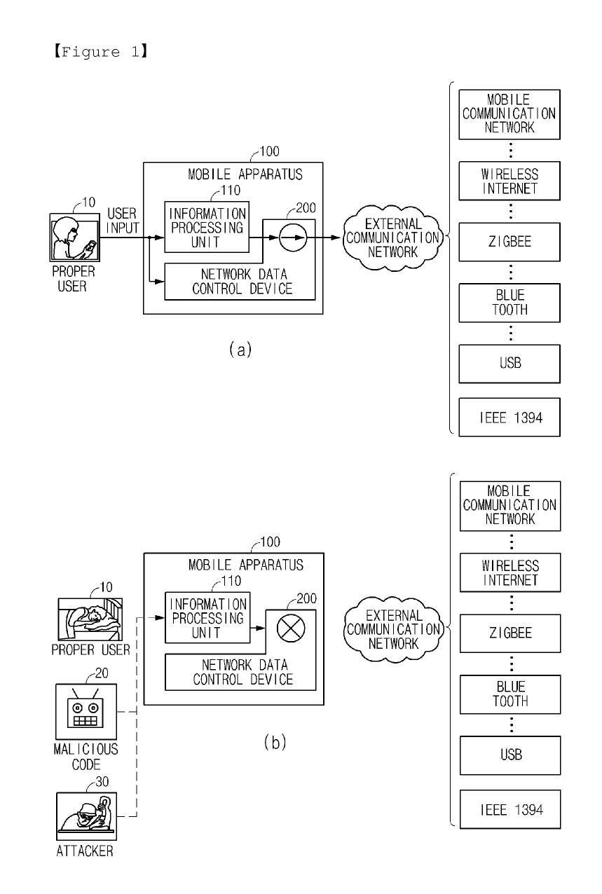

FIG. 1 is a diagram illustrating a concept of a network data control method performed by an apparatus (hereinafter, referred to as a “network data control device”) which controls network data generated by a malicious code of a mobile apparatus, according to an exemplary embodiment of the present invention.

In the present invention, the network data control device may be installed in a mobile apparatus 100 in a software manner, or the network data control device may be mounted on the mobile apparatus 100 in a hardware manner such as an ASIC chip.

A normal network data process will be described with reference to (a) of FIG. 1. If a proper user 10 inputs information by using an input unit of the mobile apparatus, an information processing unit 110 which implements basic function of the mobile apparatus 100 performs an information process according to the input information to generate network data.

Herein, the input unit through which the user inputs the information may be a touch screen, a keypad, an audio recognition unit, or the like which is installed in the mobile apparatus 100. Similarly to a general smart phone, the information processing unit 110 generates the network data in order to perform functions of making a phone call, transmitting an SMS message, or accessing wireless Internet for data communication according to user input.

At this time, the network data control device 200 together with the information processing unit 110 receives the information which the user inputs by using the input unit. In addition, the network data control device 200 receives the network data generated by the information processing unit 110 and compares the information input by the user with the network data to determine whether or not the network data are generated in accordance with user's intention. If it is determined that the network data are generated in accordance with user's intention, as illustrated in (a) of FIG. 1, the network data control device 200 transmits the network data to an external communication network. If it is determined that the network data are generated irrespective of user's intention, as illustrated in (b) of FIG. 1, the network data control device 200 blocks transmission of the network data to the external communication network.

For example, as illustrated in (a) of FIG. 1, when the user is to make a phone call, the user selects an icon indicating a phone call function displayed on a wall paper of a touch screen of the smart phone or pushes a call button of a mobile phone to activate the phone call function and input a phone number. At this time, the input information is input to the information processing unit 110 and the network data control device 200.

The information processing unit 110 generates the network data corresponding to the user input information and outputs the network data to the network data control device 200. The network data control device 200 recognizes based on the user input information that the phone call function is activated. If the network data corresponding to the phone call function are input from the information processing unit 110, since the user input corresponding to the network data exists, the network data control device 200 determines that the input network data are in accordance with user's intention and transmits the network data to the external communication network. Herein, it should be noted that the external communication network includes a wired Internet, a wireless Internet, a mobile communication network, a local area network (LAN), electronic apparatuses connected through Zigbee, Bluetooth, USB, or IEEE 1394 method in a broad sense.

On the other hand, as illustrated in (b) of FIG. 1, if the information processing unit 110 generates the network data and outputs the network data to the network data control device 200, the network data control device 200 checks whether or not user input information corresponding to the input network data exists.

In the case illustrated in (b) of FIG. 1, the user does not input information, but the information processing unit 110 itself generates the network data. Therefore, since the user input information corresponding to the network data input from the information processing unit 110 does not exist, the network data control device 200 determines that the network data are generated by a malicious code, a virus, or the like residing in the mobile apparatus 100 or remotely generated by an external attacker and blocks transmission of the network data to the external communication network.

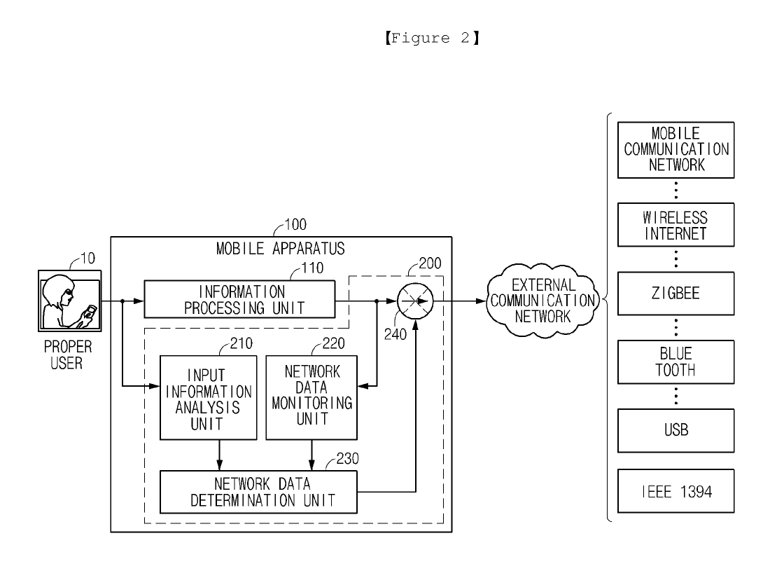

FIG. 2 is a detailed block diagram illustrating a configuration of the network data control device 200 according to an exemplary embodiment of the present invention. The network data control device 200 according to the exemplary embodiment of the present invention will be described with reference to FIG. 2.

According to the present invention, the network data control device 200 is configured to include an input information analysis unit 210, a network data monitoring unit 220, a data transmission unit 240, and a network data determination unit 230.

First, the input information analysis unit 210 analyzes the information which the user inputs through the input unit of the mobile apparatus 100 and outputs first identification information used for identifying a program executed by the user to the network data determination unit 230.

As described above, the input unit may be implemented with a touch screen, a keypad, an audio recognition unit, or the like installed in the mobile apparatus 100. In addition, the input information analysis unit 210 analyzes the user input information and generates the first identification information containing only the information used for identifying the program executed by the user or generates the first identification information containing the information used for identifying the program executed by the user and the data content input by the user by using the executed program. In addition, the input information analysis unit 210 outputs the first identification information to the network data determination unit 230.

For example, in case of the mobile apparatus 100 based on the touch screen, when the user selects a web browser icon to execute a web browser in order to access the Internet, a signal associated with a coordinate of the web browser icon is transmitted to the information processing unit 110, so that a application program corresponding to the coordinate is executed to access the Web.

At this time, the input information analysis unit 210 reads the coordinate of the icon selected by the user and identifies the executed program. If the user inputs information such as URL into the web browser, the input information analysis unit 210 extracts the URL information through the touch screen, the keypad, or the like and generates the first identification information containing program identification information (in this example, information on a web browser) and user input data (in this example, URL information) to output the first identification information to the network data determination unit 230.

Similarly, in the case where the user makes a phone call, if the user selects an icon indicating the call function on the touch screen or pushes a call button on the keypad and inputs a phone number, the input information analysis unit 210 generates the first identification information containing the program identification information indicating the call function and the user input data (phone number) and outputs the first identification information to the network data determination unit 230.

In addition to the above-described examples, the function of identifying the program executed by the user and the user input data by using the information actually input by the user can be implemented in various manners. In some specific examples, the input information analysis unit 210 may cooperatively operate with the information processing unit 110 to receive the information on the currently-executed program and the user input data from the information processing unit 110.

In addition, like the case where the user performs scheduled sending of an e-mail or scheduled sending of an SMS message, in the case where the network data are not immediately executed and sent, the input information analysis unit 210 allows the schedule information to be further contained in the first identification information and outputs the first identification information to the network data determination unit 230.

For example, after the user produces a mail through the web browser or executes an SMS transmission program to input content, in the case where the user inputs the scheduled sending time for scheduled sending, the information processing unit 110 which is input with the signal generated on the touch screen executes the application program to perform scheduling. After storing the content when it is a time defined by internal time information, the information processing unit 110 sends the mail or the SMS message.

In this case, the input information analysis unit 210 extracts the information which the user inputs in the column for inputting the schedule information on the touch screen. The input information analysis unit 210 may generate the schedule information which the user inputs after producing the content of the mail on the web browser or the schedule information which the user inputs after producing the SMS message. The input information analysis unit 210 may also generate the schedule information after receiving the schedule information from the information processing unit 110. The generated schedule information is contained in the first identification information to be transmitted to the network data determination unit 230.

On the other hand, the network data monitoring unit 220 is input with the network data from the information processing unit 110 and checks the header information and the data content of the network data. The network data monitoring unit 220 generates the second identification information containing the information used for identifying the program which generated the network data and the data content and outputs the second identification information to the network data determination unit 230.

For example, the network data monitoring unit 220 extracts protocol information, which is associated with the application program that is the information required for determining user's intention, from the network data and outputs the second identification information containing the protocol information to the network data determination unit 230. Since the application program associated with the network is in one-to-one correspondence with a specific protocol, if the information associated with the protocol is extracted from the network data and the information is output to the network data determination unit 230, the network data determination unit 230 can recognize based on the protocol information which application program generates the network data.

In addition, the network data contain information on a sender, a receiver, an application service, and the like required for determining whether or not the user generates the network data.

Therefore, the network data monitoring unit 220 extracts the user input data as well as the header information such as the protocol information for determining user's intention from the corresponding areas of the network data and outputs the user input data and the like to the network data determination unit 230.

The data transmission unit 240 temporarily stores the network data, which are generated by the information processing unit 110 and input to the data transmission unit 240, and blocks transmission of the network data or transmits the network data to the external communication network according to the control signal input from the network data determination unit 230.

If the second identification information is input from the network data monitoring unit 220, the network data determination unit 230 checks whether or not the first identification information corresponding to the second identification information exists and determines whether the network data output from the information processing unit 110 is the network data generated in accordance with user's intention or the network data generated by a malicious code or an external attacker. The network data determination unit 230 generates the control signal of instructing transmission or block of the network data according to determination result and outputs the control signal to the data transmission unit 240.

In the case where the network data are generated in the information processing unit 110, if the second identification information is input from the network data monitoring unit 220 to the network data determination unit 230 and the first identification information corresponding to the second identification information is not input from the input information analysis unit 210, the network data are not data that generated from the user input. Therefore, the network data determination unit 230 determines that the network data are generated from the malicious code existing in the information processing unit 110 or by an external attacker, so that personal information of the user is extruded or network attack data are transmitted through the external communication network. Therefore, the network data determination unit 230 transmits a control signal blocking transmission of the network data to the external communication network to the data transmission unit 240.

On the other hand, in the case where the first identification information corresponding to the second identification information is input from the input information analysis unit 210 at real time or the first identification information which contains the schedule information and is input in advance and received at the scheduled time exists, the network data determination unit 230 determines that the network data are generated in accordance with user's intention and transmits the control signal instructing outputting of the network data to the data transmission unit 240.

However, the network data determination unit 230 determines whether or not the network data are generated in accordance with user's intention in a flow unit of the network data. A TCP/IP based network apparatus opens a session through 3-way handshaking with a counterparty network apparatus for communication. After the TCP/IP based network apparatus receives and transmits the network data in the session for communication, the TCP/IP based network apparatus closes the session to end the session according to a session ending signal.

The state from the time when the session is opened to start communication to the time when the session is closed is referred to as a flow. All network data of the flow are not generated according to user input. In other words, at the initial stage, the network data are generated and a flow is generated according to a user command, and after that, the network data of the flow are generated by the associated program without a user input signal and are transmitted to the counterparty apparatus.

Therefore, in the case where the network data are not monitored in units of a flow, since the network data generated without a user input signal cannot be classified into the network data generated according to use intention and the network data generated by the malicious code, the network data determination unit 230 manages generation, updating, extinction, and the like of the network flow and determines whether the network data are the network data generated by the user in units of a flow.

In addition, in the case where the first identification information and the second identification information are configured to include only the information associated with the program, the network data determination unit 230 determines whether or not the program executed by the user and the program generating the network data are the same program to determine whether or not the network data are generated by the user. However, in the case where the first identification information and the second identification information are configured to further include the user input data, the network data determination unit 230 further determines whether or not the user input data are also the same to determine whether or not the network data are proper network data which are generated in accordance with user's intention. For example, network data which are to be transmitted to a network server which does not correspond to URL input by a user and an SMS message which is to be transmitted to a phone number other than a phone number input by a user are not in accordance with user's intention. Therefore, in this case, the network data and the SMS message needs to be blocked.

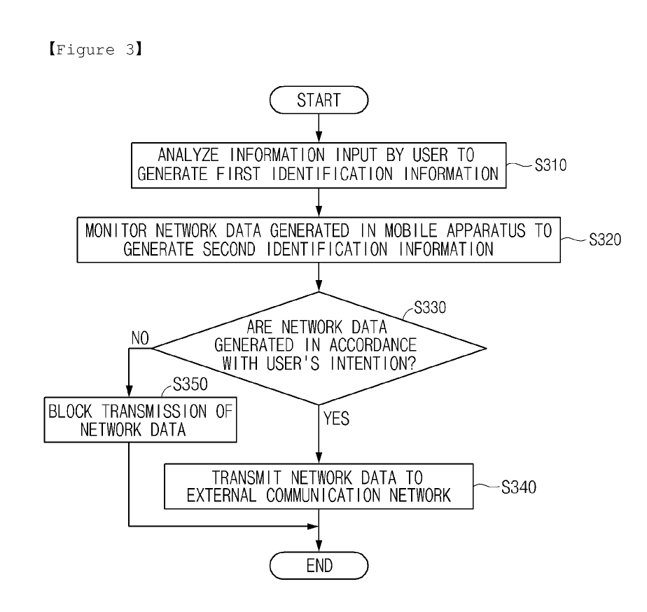

FIG. 3 is a flowchart illustrating a network data control method of controlling network data generated by a malicious code of a mobile apparatus 100 according to an exemplary embodiment of the present invention. Since the functions illustrated in FIG. 3 are the same as those described above with reference to FIGS. 1 and 2, hereinafter, the flow of the network data control method accordingly the present invention will be described in brief.

First, the network data control device 200 installed in the mobile apparatus 100 analyzes the information input by the user through the input unit of the mobile apparatus 100 to generate the first identification information used for identifying the program executed by the user (S310). The method of identifying the program by analyzing the information input by the user through the touch screen or the like are the same as those described above, and the first identification information may further contain the data content and the schedule information input by the user as described above.

On the other hand, if the information processing unit 110 generates the network data, the network data control device 200 temporarily stores the network data generated by the mobile apparatus 100 and monitors the network data to generate the second identification information used for identifying the program generating the network data (S320). The second identification information may contain the protocol information or the like extracted from the header information of the network data and the second identification information may further contain the data content input by the user as described above.

If the second identification information is generated, the network data control device checks whether the first identification information corresponding to the second identification information exists and determines whether the network data generated from the information processing unit 110 are generated in accordance with user's intention (S330). Since the method of determining whether the network data are generated in accordance with user's intention is described above, detailed description thereof is omitted.

If it is determined that the network data are generated in accordance with user's intention, the network data control device transmits the temporarily-stored network data to the external communication network (S340). If it is determined that the network data are generated irrespective of user's intention, the network data control device blocks transmission of the temporarily-stored network data to an external portion (S350).

The invention can also be embodied as computer readable codes on a computer readable recording medium. The compute r readable recording medium is any data storage device that can store data which can be thereafter read by a computer sy stem. Examples of the computer readable recording medium in clude read-only memory (ROM), random-access memory (RAM), CD-ROMs, magnetic tapes, floppy disks, optical data storage de vices, and carrier waves (such as data transmission through the Internet). The computer readable recording medium can a lso be distributed over network coupled computer systems so that the computer readable code is stored and executed in a distributed fashion.

While the present invention has been particularly shown and described with reference to exemplary embodiments thereof, it will be understood by those skilled in the art that various changes in form and details may be made therein without departing from the spirit and scope of the present invention as defined by the appended claims.

1. A network data control device which is installed in a mobile apparatus to control network data induced by a malicious code of the mobile apparatus,
wherein the network data control device analyzes information which is input by a user through an input unit of the mobile apparatus and blocks transmission of the network data which are not in accordance with user's intention to an external communication network.

2. The network data control device according to claim 1, comprising:
an input information analysis unit which analyzes the information which is input by the user through the input unit of the mobile apparatus;
a network data monitoring unit which monitors the network data generated in the mobile apparatus;
a data transmission unit which transmits the network data to the external communication network or blocks the transmission of the network data to the external communication network according to a control signal; and
a network data determination unit which outputs the control signal instructing the blocking of transmission of the network data if it is determined based on a result of the analysis of the input information analysis unit that the network data is not in accordance with user's intention.

3. The network data control device according to claim 2,
wherein the input information analysis unit analyzes the information which is input by the user through the input unit of the mobile apparatus and outputs first identification information which is used for identifying a program executed by the user,
wherein the network data monitoring unit monitors the network data which are generated in the mobile apparatus to generate second identification information which is used for identifying a program generating the network data,
wherein the data transmission unit receives the network data, temporarily stores the network data, and transmits the temporarily stored network data to the external communication network according to the control signal, and
wherein the network data determination unit searches for the first identification information corresponding to the second identification information and determines whether or not the network data are generated in accordance with user's intention to generate the control signal.

4. The network data control device according to claim 3, wherein the first identification information includes information indicating the program which is executed by the user and data (user input data) input by the user through execution of the program.

5. The network data control device according to claim 3, wherein the second identification information includes header information indicating a program which generates the network data extracted from the network data and data (user input data) input by the user.

6. The network data control device according to claim 3, wherein the input unit of the mobile apparatus includes at least one of a touch screen, a keypad, and an audio recognition unit.

7. The network data control device according to claim 6, wherein the input information analysis unit recognizes the executed program by identifying a position of an icon selected by the user on the touch screen or recognizes the program driven by the user pushing a select button on the keypad to generate the first identification information.

8. The network data control device according to claim 3, wherein, in the case where the first identification information corresponding to the second identification information exists, the network data determination unit determines that the network data are generated in accordance with user's intention, generates the control signal instructing the transmission of the network data, and outputs the control signal to the data transmission unit.

9. The network data control device according to claim 8, wherein the network data determination unit determines in units of a flow of the network data whether or not the first identification information corresponding to the second identification information exists.

10. The network data control device according to claim 3,
wherein, in the case where the program executed by the user generates schedule information, the input information analysis unit outputs the first identification information including the schedule information to the network data determination unit, and
wherein the network data determination unit searches for the first identification information corresponding to the second identification information which arrives at a scheduled time and determines whether or not the network data are generated in accordance with user's intention.

11. A network data control method performed in a network data control device which is installed in a mobile apparatus to control network data induced by a malicious code of the mobile apparatus, comprising steps of:
(a) the network data control device, analyzing information which is input by a user through an input unit of the mobile apparatus; and
(b) the network data control device, blocking transmission of the network data which are not in accordance with user's intention to an external communication network according to a result of the analysis.

12. The network data control method according to claim 11, wherein the step (b) includes steps of:
(b1) the network data control device, temporarily storing the network data generated in the mobile apparatus;
(b2) the network data control device, determining based on a result of the analysis of the step (a) whether or not the network data are generated in accordance with user's intention; and
(b3) if it is determined that the network data are generated irrespective of user's intention, the network data control device, blocking the transmission of the temporarily stored network data to the external communication network.

13. The network data control method according to claim 12,
wherein, in the step (a), the network data control device analyzes the information which is input by the user through the input unit of the mobile apparatus and generates first identification information which is used for identifying a program executed by the user,
wherein, in the step (b1), the network data control device temporarily stores the network data generated in the mobile apparatus and monitors the network data to generate second identification information which is used for identifying a program generating the network data,
wherein, in the step (b2), the network data control device searches for the first identification information corresponding to the second identification information and determines whether or not the network data are generated in accordance with user's intention, and
wherein, in the step (b3), if it is determined that the network data are generated in accordance with user's intention, the network data control device transmits the temporarily stored network data to the external communication network.

14. The network data control method according to claim 13, wherein the first identification information includes information indicating the program which is executed by the user and data (user input data) input by the user through execution of the program.

15. The network data control method according to claim 13, wherein the second identification information includes header information indicating a program which generates the network data extracted from the network data and data (user input data) input by the user.

16. The network data control method according to claim 13, wherein the input unit of the mobile apparatus includes at least one of a touch screen, a keypad, and an audio recognition unit.

17. The network data control method according to claim 16, wherein, in the step (a), the network data control device recognizes the executed program by identifying a position of an icon selected by the user on the touch screen or recognizes the program driven by the user pushing a select button on the keypad to generate the first identification information.

18. The network data control method according to claim 13, wherein, in the step (b2), the network data control device determines in units of a flow of the network data whether or not the first identification information corresponding to the second identification information exists.

19. The network data control method according to claim 13,
wherein, in the step (a), in the case where the program executed by the user generates schedule information, the network data control device allows the schedule information to be included in the first identification information, and
wherein, in the step (b2), the network data control device searches for the first identification information corresponding to the second identification information which arrives at a scheduled time and determines whether or not the network data are generated in accordance with user's intention.

20. A non-transitory computer-readable medium having recorded thereon program codes for causing a computer to execute the network data control method of claim 1.
